(19) United States
(12) Patent Application Publication
(10) Pub. No.: US 2011/0187742 A1
(43) Pub. Date: Aug. 4, 2011

(54) ELECTRONIC DEVICE AND METHOD OF SWITCHING IMAGES

(75) Inventor: TENG-YU TSAI, Tu-Cheng (TW)

(73) Assignee: HON HAI PRECISION INDUSTRY CO., LTD., Tu-Cheng (TW)

(21) Appl. No.: 12/753,063

(22) Filed: Apr. 1, 2010

(30) Foreign Application Priority Data
Feb. 1, 2010 (CN) 201010301004.5

(51) Int. Cl. G09G 5/00

(52) U.S. Cl. 345/629

(57) ABSTRACT

A method of switching images on an electronic device is disclosed. The method includes displaying a first image on a top layer of display. A to-be-displayed second image is decoded and loaded to a virtual position behind the first image. The first image is moved a predetermined distance on the display at set time period. The second image shows on the display little by little until the entire first image has moved to a position outside the area defined by the display. The second image is displayed on the display.

### BACKGROUND

1. Technical Field

The present disclosure relates to electronic devices, and particularly to a method of switching displayed images on an electronic device.

2. Description of Related Art

Electronic devices (such as digital photo frames) typically allow image browsing by touching the display or by a remote control. Images are stored in a flash storage of the electronic device. The electronic device decodes the images and stores the images in a buffer memory for display. When the user switches the displayed image to next one, the displayed image may immediately disappear and the next image immediately be displayed on the screen. However, in this way, switch effect of the images may be tedious and boring for the user.

### BRIEF DESCRIPTION OF THE DRAWINGS

FIG. 1 shows an electronic device in accordance with an exemplary embodiment.

FIG. 2 is a block view of the electronic device in accordance with an exemplary embodiment.

FIG. 3 is a flowchart of a method of switching images on electronic devices such as that of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language such as Java, C, or Assembly. One or more software instructions in the modules can be embedded in firmware, such as an EPROM. Modules may comprise connected logic units, such as gates and flip-flops, and programmable units such as programmable gate arrays or processors. The modules described herein implemented as software and/or hardware modules and may be stored in any type of computer-readable medium or other computer storage device.

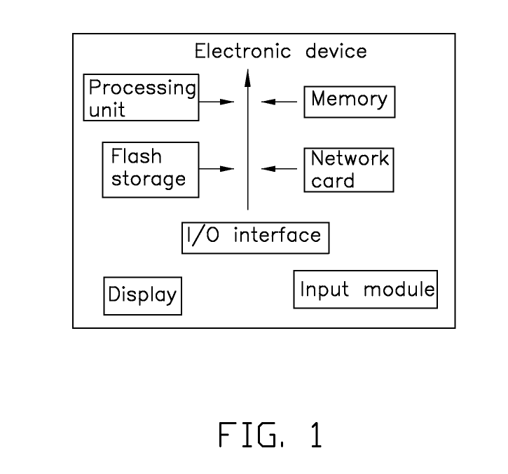

Referring to FIG. 1, an electronic device includes a processing unit, a memory, an Input/Output (I/O) interface, a network card, a display, an input module and flash storage. The display may be touch-sensitive or displays a user interface. The input module may be a remote controller. The electronic device may be a digital photo frame, a media player, or a personal computer.

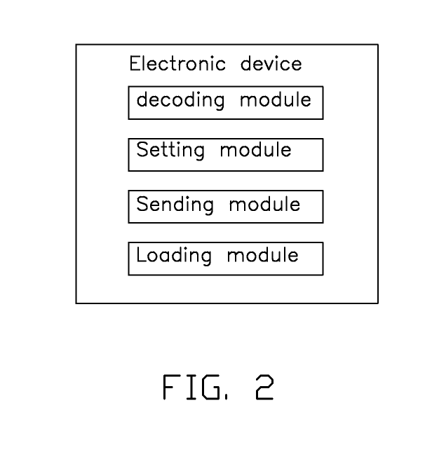

Referring to FIG. 2, the electronic device includes a decoding module, a setting module, a sending module and a loading module. The display displays a first image on a top layer for a first time period. To save time, the decoding module takes a second time period to decode the second image time period that the first image is displayed. The second image is loaded to a virtual position behind the first image. Therefore, the first image blocks or hides the second image. The second time period is shorter than or equal to the first time period. The setting module may configure a predetermined distance that the first image can move and a third time period before which the first image can move to expose the second image. In one exemplary embodiment, the third time period is 0.2 seconds.

The first image is moved the predetermined distance during the third time period after the first image is displayed during the first time period. The predetermined distance is shorter than the width of the display. Therefore, a portion of the second image shows on the display from behind the first image. Repeatedly moving the first image the predetermined distance during the third time period until the entire first image has moved to a position outside the area defined by the display and can no longer be seen. Thus, the second image is completely displayed on the display. The flash storage stores the first and second images.

The loading module may download the first and second images from the Internet. The sending module sends messages to the Internet for obtaining the first and second images. The setting module sets a switching effect between the first and second images. The user sets the first time period by setting the setting module. In one embodiment, the first time period is 8 seconds.

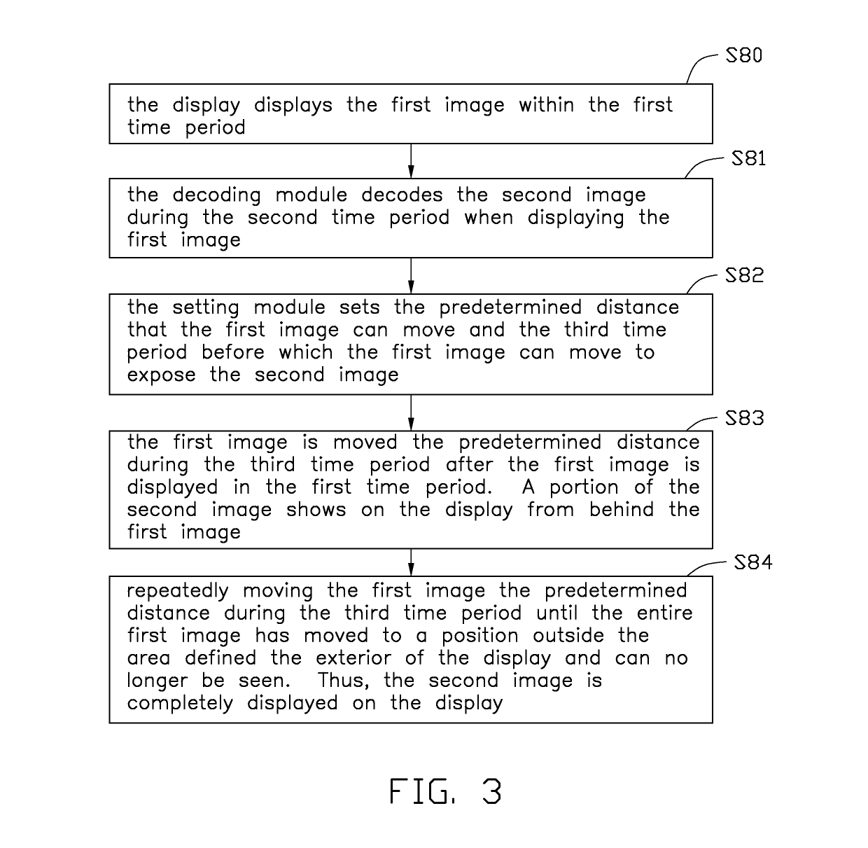

Referring to FIG. 3, one embodiment of a method of switching images using an electronic device includes the following blocks.

In block S80, the display displays the first image within the first time period.

In block S81, the decoding module decodes the second image during the second time period when displaying the first image. The second time period is shorter than or equal to the first time period.

In block S82, the setting module sets the predetermined distance that the first image can move and the third time period before which the first image can move to expose the second image.

In block S83, the first image is moved the predetermined distance during the third time period after the first image is displayed in the first time period. A portion of the second image shows on the display from behind the first image.

In block S84, repeatedly moving the first image the predetermined distance during the third time period until the entire first image has moved to a position outside the area defined by the display and can no longer be seen. Thus, the second image is completely displayed on the display.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A method of switching images on an electronic device, the method comprising:
displaying a first image on a display;
decoding a to-be-displayed second image and loading the second image to a virtual position behind the first image;
moving the first image a predetermined distance on the display at set time period, and showing the second image on the display little by little, until the entire first image has moved to a position outside the area defined by the display;
displaying the second image on the display.

2. The method of claim 1, wherein the predetermined distance is shorter than a width of the display.

3. The method of claim 1, wherein the electronic device comprises a storage, the storage stores the first and second images.

4. The method of claim 1, wherein a loading module downloads the first and second images from the Internet.

5. The method of claim 4, wherein a sending module sends messages to the Internet for obtaining the first and second images.

6. The method of claim 1, wherein a setting module sets a switching effect between the first and second images.

7. The method of claim 1, further comprising decoding the second image when the first image is displayed on the display.

8. An electronic device capable of switching images, the electronic device comprising:
a display capable of displaying a first image;
a decode module capable of decoding a to-be-displayed second image and loading the second image to a virtual position behind the first image;
wherein the first image is capable of being moved a predetermined distance on the display at set time period, and showing the second image on the display little by little, until the entire first image has moved to a position outside the area defined by the display, the second image is displayed on the display.

9. The electronic device of claim 8, wherein the predetermined distance is shorter than a width of the display.

10. The electronic device of claim 8, wherein the electronic device comprises a storage, the storage stores the first and second images.

11. The electronic device of claim 8, wherein a loading module is capable of downloading the first and second images from the Internet.

12. The electronic device of claim 11, wherein a sending module is capable of sending messages to the Internet for obtaining the first and second images.

13. The electronic device of claim 8, wherein a setting module is capable of setting a switching effect between the first and second images.

14. The electronic device of claim 8, further comprising decoding the second image when the first image is displayed on the display.
